(19) United States
(12) Patent Application Publication
(10) Pub. No.: US 2014/0363105 A1
(43) Pub. Date: Dec. 11, 2014

(54) STANDUP BAG

(71) Applicant: Berry Plastics Corporation, Evansville, IN (US)

(72) Inventors: Gary M. Pelletier, Oswego, IL (US); Frank P. Watson, Victoria, TX (US); Donnel Gray, JR., Cuero, TX (US); Douglas E. McDonald, Victoria, TX (US)

(21) Appl. No.: 13/913,193

(22) Filed: Jun. 7, 2013

(51) Int. Cl. B65D 33/02; C08L 23/06; B65D 33/16

(52) U.S. Cl. CPC B65D 33/02; B65D 33/16; C08L 23/06
USPC 383/104; 525/240; 524/528; 524/427

(57) ABSTRACT

A bag includes a body and a floor coupled to a bottom end of the body to define an interior region therebetween. A mouth is formed in a top end of the body and is arranged to open into the interior region. The body and floor of the bag are made from plastics materials.

### BACKGROUND

The present disclosure relates to a bag, and in particular to a bag made of plastics materials. More particularly, the present disclosure relates to a bag with a closable mouth.

### SUMMARY

According the present disclosure, a bag includes a body and a floor appended to the body to define an interior region therebetween. The body is formed to include a mouth opening into to the interior region opposite the floor. The body and the floor are made from plastics materials.

In illustrative embodiments, the plastics materials are configured to provide means for supporting the body on ground underlying the body after the bag has been has been unfolded and arranged to be free standing so that the mouth opens into the storage space. The mouth remains open and the body remains extending upwardly away from ground without support from a user or a bag-support structure.

In illustrative embodiments, the plastics materials comprise high density polyethylene (HDPE) and low density polyethylene (LDPE). The HDPE comprises about 20% to about 40% of the weight of the material. The LDPE comprises about 20% to about 40% of the weight of the film.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a diagrammatic view of a bag-forming process in accordance with the present disclosure showing that the bag-forming process includes the steps of blending high density polymeric material, low density polymeric material, and other materials in a blender, extruding the blended materials, forming the extruded material into a blown tube using a tube former, forming gussets along two sides of the blown tube, forming a folded standup bag as suggested in FIG. 2 using a folding machine, and packaging several folded standup bags for transport or storage using a packaging machine;

FIG. 2 is a perspective view of a first embodiment of a standup bag formed using the bag-forming process of FIG. 2 showing the standup bag in a folded arrangement;

FIG. 3 is a perspective view of the stand-up bag of FIG. 2 in an unfolded-use arrangement in which the standup bag has been unfolded and arranged to rest on ground underlying the standup bag to cause the standup bag to be free standing without support from a user or other bag-support structure (e.g., a trash bin);

FIG. 4 is a view similar to FIG. 2 showing the standup bag in the folded arrangement;

FIG. 5 is a view similar to FIG. 3 showing the standup bag in the unfolded-use arrangement in which the standup bag arranged to cause an open mouth to be established that opens into a storage space formed in the standup bag so that waste may be placed in the storage space without a user supporting the standup bag or holding the mouth open;

FIG. 6 is a view similar to FIG. 5 showing the standup bag in a closed arrangement in which flaps appended to the walls of the standup bag are gathered together to close the open mouth after that standup bag has been filled;

FIG. 7 is a partial plan view of the standup bag arranged is a strip of standup bags after the standup bag has been formed in the folding machine but prior to folding of the standup bag by the folding machine;

FIG. 8 is a sectional view taken along line 8-8 of FIG. 7 showing that that the standup bag includes, from left to right, a first gusset, a first wall, a second wall, and a second gusset;

FIG. 9 is a perspective view of a second embodiment of a standup bag in accordance with the present disclosure showing the standup bag in a folded arrangement;

FIG. 10 is a perspective view of a second embodiment of a stand-up bag in accordance with the present disclosure showing the standup bag in an unfolded-use arrangement in which the standup bag has been unfolded and arranged to rest on ground underlying the standup bag to cause the standup bag to be free standing without support from a user or other bag-support structure;

FIG. 11 is a view similar to FIG. 10 showing the standup bag in a closed arrangement in which a top portion of the standup is gathered together to close the open mouth after that standup bag has been filled;

FIG. 12 is a partial plan view of the standup bag arranged is a strip of standup bags after the standup bag has been formed in the folding machine but prior to folding of the standup bag by the folding machine; and

FIG. 13 is a sectional view taken along line 13-13 of FIG. 12 showing that that the standup bag includes, from left to right, a gusset, a first wall, and a second wall.

### DETAILED DESCRIPTION

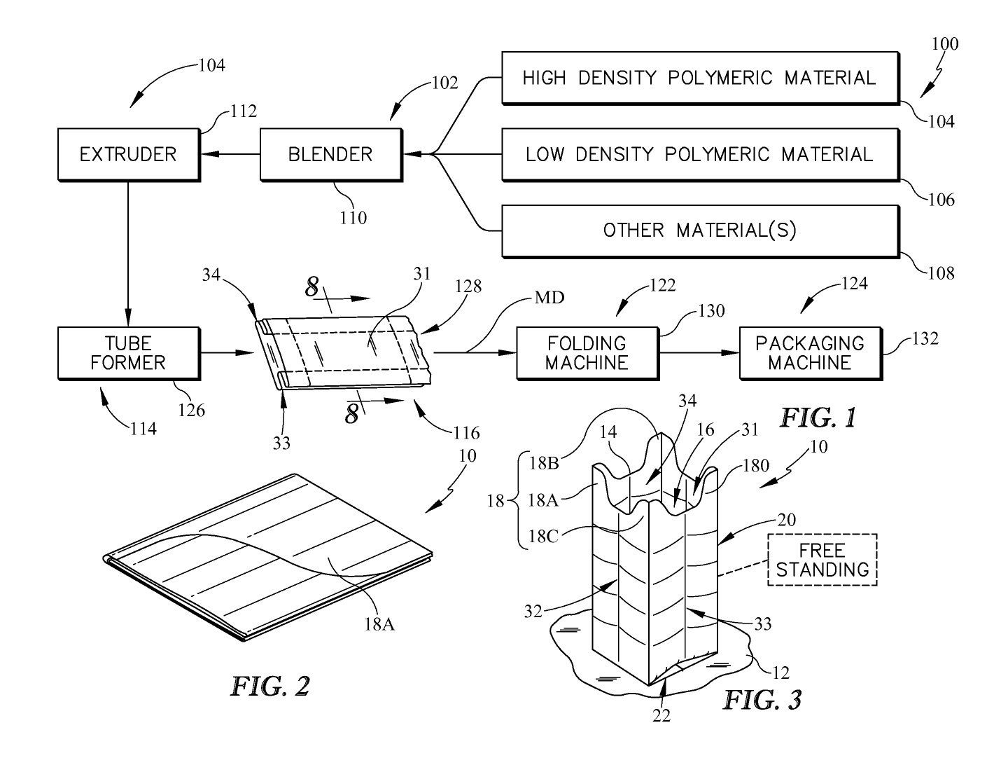

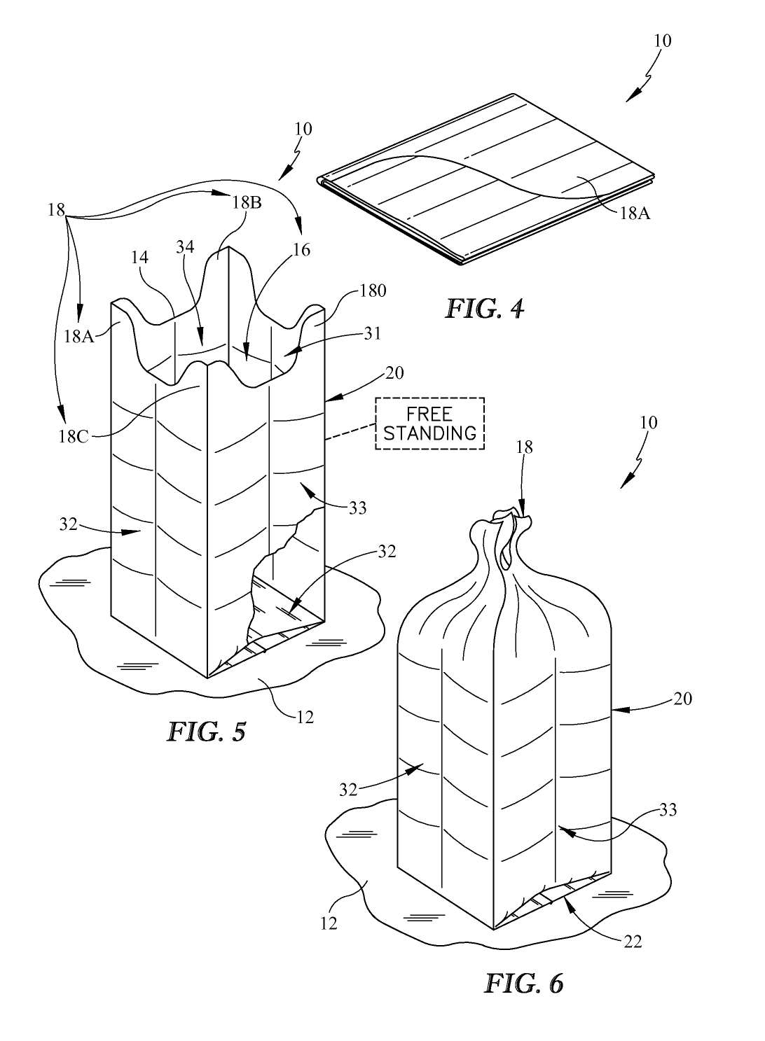

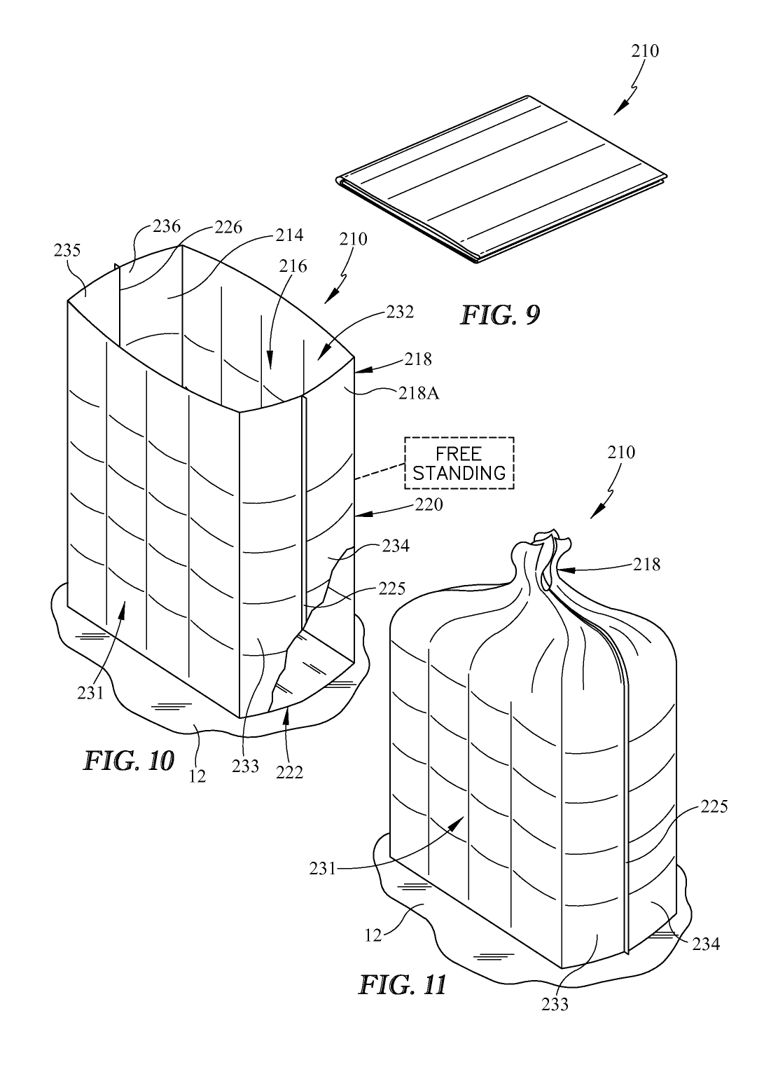

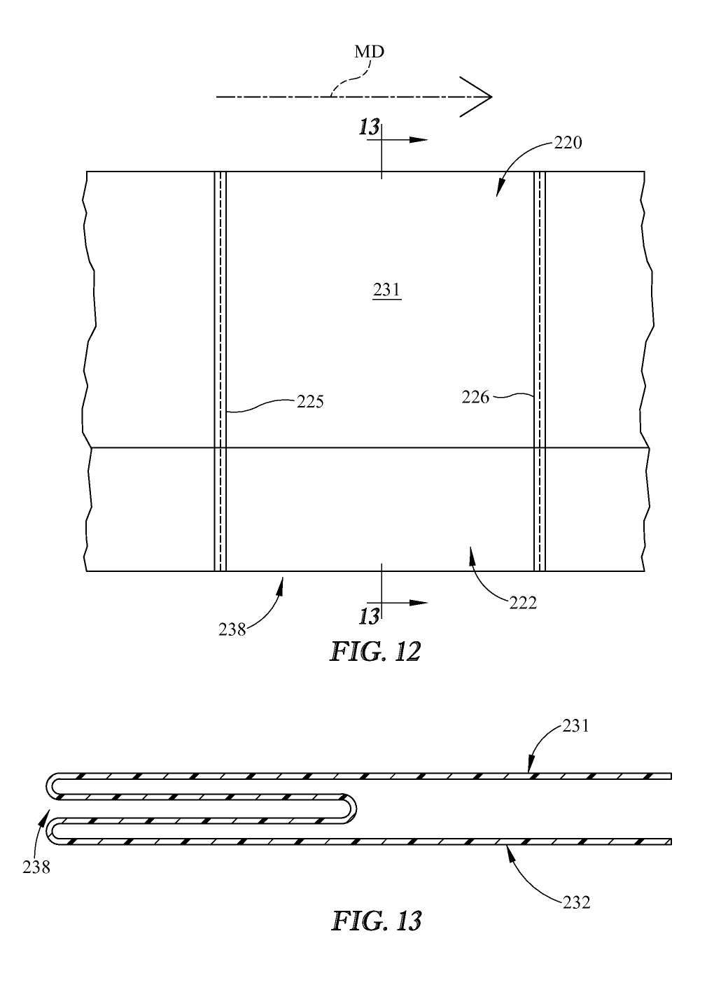

A first embodiment of a standup bag 10 in accordance with the present disclosure is shown, for example, in a folded arrangement in FIG. 2 and in an unfolded-use arrangement in FIG. 3. As suggested in FIG. 3, the standup bag is made from plastics materials which are configured to provide means for supporting standup bag 10 on ground 12 underlying standup bag 10 after standup bag 10 has been unfolded and arranged to be free standing without support from a user or other bag-support structures (e.g., a trash bin) so that a mouth 14 formed in standup bag opens into a storage space 16 formed in standup bag 10. Standup bag 10 is formed in an illustrative bag-forming process 100 as shown in FIG. 1. Another embodiment of a standup bag 210 in accordance with the present disclosure is shown, for example, in FIGS. 9-11.

Standup bag 10 is formed to include mouth 14 that opens into storage space 16 as shown, for example, in FIGS. 3 and 5. Articles such as trash or debris may be placed for storage or disposal through open mouth 14 into storage space 16 for storage or disposal. Standup bag 10 is formed using bag-forming process 100 and begins in the folded arrangement as shown in FIG. 2 which minimizes storage space used by standup bag 10. A user then unfolds standup bag 10 and arranges standup bag 10 to rest on and be supported by ground 12 as shown in FIG. 3. Standup bag 10 is configured to be free standing and stand upright without support from a user or a bag-support structure so that mouth 14 is open as shown in FIG. 3.

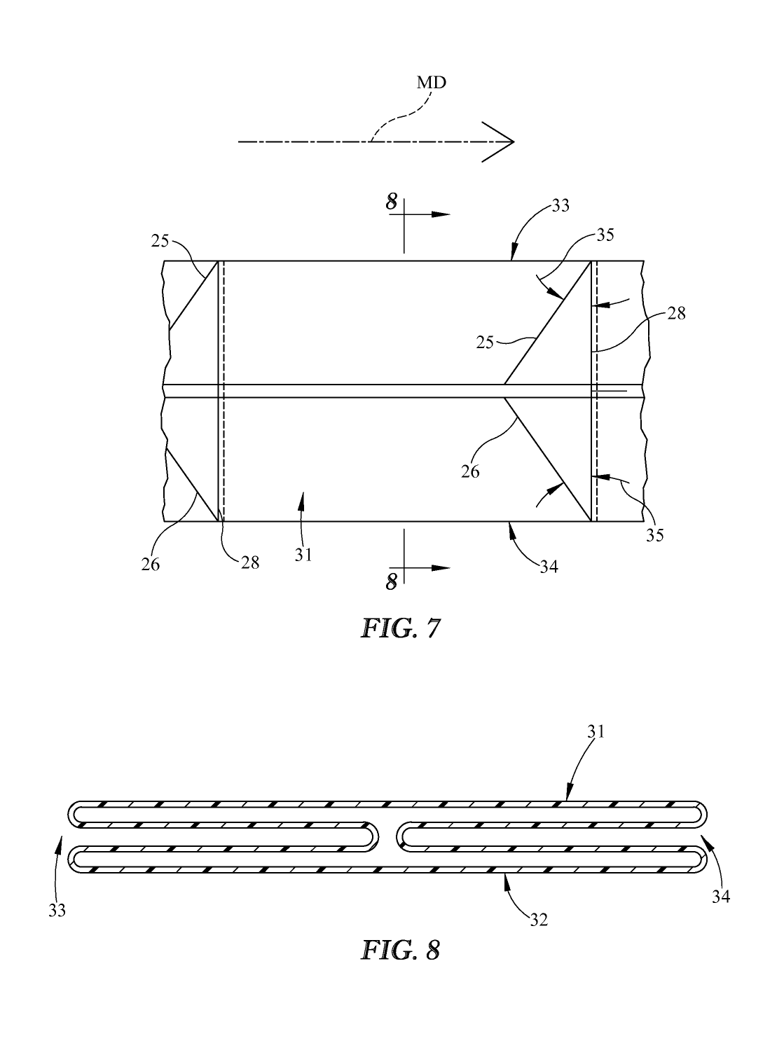

Standup bag 10 is formed in bag-forming process 100 as shown in FIG. 1. Bag-forming process 100 includes the steps of blending 102 a high-density polymeric material 104, a low-density polymeric material 106, and other materials 108 in a blender 110 and extruding 104 in the blended materials from an extruder 112 as shown in FIG. 1. Bag-forming process 100 further includes the steps of blowing 114 the extruded materials using a tube former 126 to form a blown tube 128 and forming 116 the blown tube by placing gusset boards in a machine direction MD of the blown tube so that gussets 33, 34 are established in blown tube as shown in FIG. 1. Bag-forming process 100 further includes the steps of forming 122 standup bag 10 by heat sealing portions of the blown tube as suggested in FIG. 7 and folding standup bag 10 so that the folded arrangement is established as shown in FIG. 2 using a folding machine 130. Bag-forming process 100 further includes a step of packaging 124 standup bags for storage or transportation using a packaging machine 132.

The presently described technology is further illustrated by the following examples, which are set forth for purposes of illustration only and are not to be construed as limiting the invention or scope of the specific compositions described herein. Parts and percentages are by weight unless stated otherwise.

Disclosed herein are embodiments of a blended material or resin that provides rigidity to film structures, such as standup bags 10, 210. The blended resin is a blend of high density (HD) and low density (LD) polymeric materials. In one illustrative embodiment, a blended film comprises HD polyethylene (HDPE) and LD polyethylene (LDPE).

Rigidity is one property a material that in turn depends on two other properties of a material. As a result, rigidity is a function of sample thickness measured in gauge and sample stiffness. Stiffness is an inherent property of a material of which the film or sheet is made. The combined effect of these two factors is the rigidity that influences performance on converting machines. Rigidity of a polyolefin film can be measured by ASTM D2923-08. In one embodiment, a blended HDPE/LDPE film has a rigidity associated with an outside face, an inside face, and overall.

In one embodiment, a blended HDPE/LDPE film has a rigidity of at least about 325 mg*cm (milligram×centimeter). In another embodiment, a blended HDPE/LDPE film has a rigidity of about 325 mg*cm to about 450 mg*cm, about 345 mg*cm to about 450 mg*cm, about 350 mg*cm to about 450 mg*cm, about 355 mg*cm to about 450 mg*cm, about 360 mg*cm to about 450 mg*cm, about 370 mg*cm to about 450 mg*cm, about 375 mg*cm to about 450 mg*cm, about 325 mg*cm to about 445 mg*cm, about 325 mg*cm to about 440 mg*cm, about 325 mg*cm to about 430 mg*cm, about 325 mg*cm to about 425 mg*cm, about 325 mg*cm to about 420 mg*cm, about 325 mg*cm to about 415 mg*cm, about 325 mg*cm to about 410 mg*cm, or about 325 mg*cm to about 405 mg*cm. In another embodiment, a blended HDPE/LDPE film has a rigidity (outside face, inside face, or overall) of at least about 325 mg*cm, about 330 mg*cm, about 335 mg*cm, about 345 mg*cm, about 350 mg*cm, about 355 mg*cm, about 360 mg*cm, about 365 mg*cm, about 370 mg*cm, about 375 mg*cm, about 380 mg*cm, about 390 mg*cm, about 395 mg*cm, about 400 mg*cm, about 405 mg*cm, about 410 mg*cm, about 415 mg*cm, about 420 mg*cm, about 425 mg*cm, about 430 mg*cm, about 435 mg*cm, about 440 mg*cm, about 445 mg*cm, or about 450 mg*cm.

In an embodiment, a blended HDPE/LDPE film is used in the production of standup bags 10, 210. A standup bag in accordance with the present disclosure has a square or rectangular shape, but may have any other suitable shape like circular.

LDPE. As used herein, low density polyethylene (LDPE) is defined as a polyethylene polymer with a density in the range of about 0.91 g/cm³ to about 0.93 g/cm³. LDPE may be polymerized through a free radical polymerization and has a high degree of short and long chain branching. The term LDPE is intended to include high pressure low density polyethylene (HPLDPE) polymerized through a high pressure free radical polymerization. For example, LDPE may be an ethylene homopolymer made using a free radical initiator at pressures from about 15,000 psi to about 50,000 psi and at temperature up to about 300° C. in a tubular or stirred reactor. According to this polymerization technique, numerous long chain branches may be formed along the length of the polymer. In one aspect, the LDPE may be characterized as having a single low melting point. For example, a 0.92 g/cm³ density LDPE would typically have a melting point at about 112° C. In another aspect, LDPE may not pack into the crystal structures well. Therefore, LDPE may have a tendency to form amorphous solid structures. Accordingly, the intermolecular forces are weaker and the instantaneous-dipole induced-dipole attraction may be lower. Furthermore, LDPE has a lower tensile strength than HDPE but comparably greater ductility.

In illustrative embodiments, the film comprises LDPE having a Melt Index (MI) of about 0.1 g/10 min to about 20 g/10 min. In one embodiment, the film comprises LDPE having a MI of about 2 g/10 min. In another embodiment, the film comprises LDPE having a MI of about 0.2 g/10 min. In illustrative embodiments, the film comprises LDPE having a density of about 0.91 g/cm³ to about 0.93 g/cm³. In another embodiment, the film comprises LDPE having a density of about 0.92 g/cm³.

HDPE. In illustrative embodiments, the multilayer film includes at a layer comprised of high density polyethylene, referred to herein as HDPE. In another embodiment, the high density polyethylene is a product of reacting ethylene by a means to form a product exhibiting very little short chain or long chain branching so that the polyethylene has a highly crystalline structure.

In illustrative embodiments, the high density polyethylene is a homo-polymeric high density polyethylene with a mono-modal Molecular Weight Distribution (MWD). The homo-polymeric high density polyethylene is a product of reacting ethylene such that the product has substantially no branching. In one embodiment, the homo-polymeric high density polyethylene has a MI of about 1 g/10 min to 9 g/10 min and a density of about 0.935 g/cm³ to about 0.96 g/cm³.

LLDPE. As used herein, linear low-density polyethylene (LLDPE) is used to describe a copolymer of ethylene and an alpha olefin comonomer made through a single site catalyzed reaction (e.g., through a metallocene catalyzed reaction (mLLDPE)), or Ziegler Natta catalysts. Included within the scope of the present disclosure are physical blends of LLDPE with an elastomer or high pressure low density polyethylene. LLDPE, as used herein, includes polymers made through non-metallocene or post-metallocene catalyzed reactions resulting in a copolymer of ethylene and an alpha olefin copolymer. LLDPE includes copolymers made with various alpha olefin monomers including 1-butene, 3-methyl-1-butene, 1-propylene, 3-methyl-1-pentene, 1-hexene, 4-methyl-1-pentene, 3-methyl-1-hexene, 1-octene or 1-decene. The alpha olefin comonomer may be incorporated from about 1% to about 20% by weight of the total weight of the polymer. In other embodiments the alpha olefin comonomer may be incorporated from about 1% to about 10% by weight of the total weight of the polymer. LLDPE also includes copolymers incorporating long-chain branching (e.g. chains containing as many as 300 carbons). LLDPE also includes C6 and C8 LLDPE.

Linear low density polyethylene polymers (LLDPE) have a density of about 0.900 g/cc to about 0.945 g/cc. Preferably, LLDPE has a density that is less than about 0.930 g/cc. LLDPE has rapidly increasing commercial importance in commodity and industrial applications including blown and cast films, injection molding, rotational molding, blow molding, pipe, tubing, and wire and cable manufacturing. Intensive research has been directed to development of high performance LLDPE resins having improved impact strength, higher toughness, higher transparency, less low molecular weight component content, and narrower compositional distributions.

Advanced Ziegler-Natta catalysts based on supported titanium systems can produce high performance LLDPE resins, such as Super-Hexene resins. Super-Hexene resins are ethylene/hexene copolymers having narrow molecular weight distributions, uniform compositional distribution, and high performance properties comparable to ethylene-octene copolymers produced by single site catalysts. The advanced Ziegler-Natta catalysts are directly applicable to existing fluidized gas phase processes, without polymerization process modification.

Examples of commercially available ethylene-hexene-1 LLDPEs which may be used are GA 615-050 (density 0.918 g/cm³; 7 MI; Equistar Chemicals L. P.); PE 7235 (density 0.924 g/cm³; 3.5 MI; Chevron Phillips Chemical Co.); NTX 095 (ExxonMobil Chemical Co.), and LL 3003 (density 0.918 g/cm³; 3.2 MI; ExxonMobil Chemical Co.).

cPE. As used herein, the term catalyzed polyethylene (cPE) is used generally to describe a copolymer of ethylene and an alpha olefin comonomer made through a catalyzed reaction (e.g., through a Ziegler-Natta, Philips, metallocene, or other single site catalyzed reactions). cPE includes polymers made through non-metallocene or post-metallocene catalyzed reactions resulting in a copolymer of ethylene and an alpha olefin copolymer. cPE includes copolymers made with various alpha olefin monomers including 1-butene, 3-methyl-1-butene, 3-methyl-l-pentene, 1-hexene, 4-methyl-1-pentene, 3-methyl-1-hexene, 1-octene or 1-decene. In one embodiment, the cPE is a copolymer of ethylene and one selected from the group of 1-hexene and 1-octene. In another embodiment, the cPE is a copolymer of ethylene and 1-octene.

In illustrative embodiments, cPE has a MWD within the range of about 1 to about 6. In one embodiment, cPE has a MWD within the range of about 1.5 to about 5. In another embodiment, cPE has a MWD within the range of about 2 to about 4. In illustrative embodiments, the cPE has an average molecular weight from about 20,000 g/mol to about 500,000 g/mol, preferably from about 50,000 g/mol to about 200,000 g/mol.

VLDPE. As used herein, VLDPE is a cPE having a density of about 0.88 g/cm³ to about 0.92 g/cm³ or from about 0.89 g/cm³ to about 0.91 g/cm³. It may be referred to as ultra-low density polyethylene (ULDPE) or very low density polyethylene (VLDPE). VLDPE may have a MI of from about 0.5 g/10 min to about 5 g/10 min, preferably from about 1 g/10 min to about 4 g/10 min. For example, a VLDPE may have a density of about 0.91 g/cm³ and a MI of about 3 g/10 min. A VLDPE may have a density of about 0.90 g/cm³ and a MI of about 4 g/10 min. A VLDPE having a density from about 0.90 g/cm³ to about 0.91 g/cm³ and a MI of about 1 g/10 min may also be used. In one aspect, the characteristic density may have been achieved by copolymerizing ethylene with one of 1-butene, 1-hexene, 4-methyl-1-pentene, or 1-octene. In one embodiment, the VLDPE is a copolymer of ethylene and one comonomer selected from the group of 1-hexene and 1-octene. In another embodiment, the cPE is a VLDPE being a copolymer of ethylene and 1-octene, wherein copolymer has a mean comonomer percentage of about 10%.

In one embodiment, a blended film comprises HD polyethylene (HDPE) and LD polyethylene (LDPE). In another embodiment, a blended film comprises a combined LDPE and HDPE of about 50% to about 80% of the weight of the film. In an embodiment, a blended film comprises a combined LDPE and HDPE of about 50% to about 75% of the weight of the film. In an embodiment, a blended film comprises about 50% to about 60% of a combined LDPE and HDPE. In an embodiment, a blended film comprises about 55% to about 75% of a combined LDPE and HDPE. In an embodiment, a blended film comprises about 55% to about 60% of a combined LDPE and HDPE. In an embodiment, a blended film comprises about 50%, 55%, 56%, 57%, 58%, 59%, 60%, 65%, 70%, 75%, or 80% of a combined LDPE and HDPE.

In another embodiment, a blended film comprises HDPE and LDPE, wherein the blended film comprises about 20% to about 40% HDPE, about 25% to about 40% HDPE, about 30% to about 40% HDPE, about 35% to about 40% HDPE, about 25% to about 35% HDPE, about 25% to about 35% HDPE, about 25% to about 30% HDPE, or about 30% to about 35% HDPE. In an embodiment, a blended film comprises HDPE and LDPE, wherein the blended film comprises about 20%, about 21%, about 22%, about 23%, about 24%, about 25%, about 26%, about 27%, about 28%, about 29%, about 30%, about 31%, about 32%, about 33%, about 34%, about 35%, or about 40% HDPE.

In an embodiment, a blended film comprises HDPE and LDPE, wherein the blended film comprises about 20% to about 40% LDPE, about 25% to about 40% LDPE, about 30% to about 40% LDPE, about 35% to about 40% LDPE, about 25% to about 35% LDPE, about 25% to about 35% LDPE, about 25% to about 30% LDPE, or about 30% to about 35% LDPE. In an embodiment, a blended film comprises HDPE and LDPE, wherein the blended film comprises about 20%, about 21%, about 22%, about 23%, about 24%, about 25%, about 26%, about 27%, about 28%, about 29%, about 30%, about 31%, about 32%, about 33%, about 34%, about 35%, or about 40% LDPE.

In an embodiment, other materials 108 used to make a film may include include an LLDPE. In an embodiment, a LLDPE can be super hexene. In particular, the LLDPE, including super hexene, can be about 10% to about 40%, about 10% to about 30%, about 10% to about 20%, about 10% to about 15%, about 10% to about 12%, about 12% to about 15%, about 12% to about 20%, about 12% to about 30%, about 12% to about 40%, about 15% to about 30%, and about 15% to about 40%. In an embodiment, the LLDPE, including super hexene, can be about 10%, about 12%, about 15%, about 20%, about 30%, and about 40%.

In an embodiment, other materials 108 used to make a film may include calcium carbonate. In an embodiment, calcium carbonate is about 5% to about 15% of the weight of a film. In an embodiment, calcium carbonate comprises about 5%, about 8%, about 9%, about 10%, about 12%, or about 15% of the weight of a film.

In an embodiment, other materials 108 used to make a film may include a slip agent. In an embodiment, a slip agent is about 0.5% to about 2% of the weight of a film. In an embodiment, a slip agent comprises about 0.5%, about 0.75%, about 0.8%, about 0.9%, about 1.0%, about 1.1%, about 1.2% about 1.25%, about 1.5%, or about 2.0% of the weight of a film. As used herein, a slip agent is an additive used to reduce a polyolefin film's resistance to sliding. In an embodiment a slip agent can be a long chain fatty acid amide. In an embodiment, the slip agent can be an unsaturated fatty acid amide. In an embodiment, the slip agent can be a C-18, C-20, or C-22 fatty acid amide. Slip agents include, but are not limited to, about 1%, 2%, 3%, 4%, 5%, 5.5%, or 6% erucamide in LDPE, LLD, or PP. Slip agents can also include, but are not limited to, about 3% to about 12%, about 5% to about 10%, about 5%, or about 10% oleamide in LDPE, PE, or LLD.

In an embodiment, other materials 108 used to make a film may include a nucleating agent. In an embodiment, a slip agent is about 0.5% to about 4% of the weight of a film. In an embodiment, a slip agent comprises about 0.5%, about 1.0%, about 1.5%, about 2.0%, about 2.5%, about 3.0%, about 3.5%, or about 4.0% of the weight of a film.

In an embodiment, other materials 108 used to make a film may include a coloring agent. In an embodiment, a coloring agent is about 0.5% to about 4% of the weight of a film. In an embodiment, a coloring agent comprises about 0.5%, about 1.0%, about 1.5%, about 2.0%, about 2.5%, about 3.0%, about 3.5%, or about 4.0% of the weight of a film. The coloring agent may give the standup bag a black color, orange color, brown color, blue color, or white color. The coloring agent may be omitted providing a transparent, opaque, or clear bag.

ASTM standard test methods incorporated by reference. Reference is made to each ASTM standard test methods described herein, which ASTM standard test methods are hereby incorporated by reference herein, for disclosure relating to the methods for testing polymeric compositions and films made thereof.

Standup bag 10, in accordance with the present disclosure, includes a closure system 18, a body 20, and a floor 22 as shown in FIGS. 5 and 6. Storage space 16 is defined between body 20 and floor 22 and mouth 14 is formed in body 20 to open into storage space 16 as shown in FIG. 5. Closure system 18 is appended to a top portion of body 20 and configured to selectively close mouth 14 to block access to storage space 16 as shown in FIG. 6. Floor 22 is appended to an opposite bottom portion of body 20 to cause body 20 to extend upwardly away from floor 22 when standup bag is in the unfolded-use position as shown in FIGS. 3, 5 and 7.

Body 20 includes a first wall 31, a first gusset 33, a second wall 32, and a second gusset 34 as shown in FIGS. 3, 5, and 6. During bag-forming process 100, first wall 31, first gusset 33, second wall 32, and second gusset 34 are heat sealed together along a bottom seal line 28 as suggested in FIG. 7. Standup bag 10 may be known as a bottom-seal bag as a result of being heat sealed along bottom seal line 28 and two gussets 33, 34 being used to establish body 20.

Floor 22 of standup bag 10 is formed as a result of additional heat sealing which causes floor 22 to have a generally square or rectangular shape when viewed from the bottom. First gusset 33 is further coupled to first side wall 31 along a first seal line 25 which extends away from bottom seal line 28 at an angle 35 of about 35.5 degrees as measured between first seal line 25 and bottom seal line 28. First gusset 33 is also coupled to second side wall 32 along a second seal line 26 which extends away from bottom seal line 28 at the angle 35 of about 35.5 degrees as measured between second seal line 26 and bottom seal line 28 as shown in FIG. 7. Second gusset 34 is coupled to first and second walls 31, 32 in a manner similar to first gusset 34 and will not be discussed in detail. As a result of the heat sealing of first and second gussets 33, 34 to first and second walls 31, 32, floor 22 is established.

Closure system 18 is coupled to the top portion of body 20 opposite floor 22 and includes four flaps 18A, 18B, 18C, 18D as shown in FIGS. 3 and 5. After items have been placed storage space 16, flaps 18A, 18B, 18C, 18D are gathered together to close mouth 14 as shown in FIG. 6. A tie strap, for example, may be used to keep flaps 18A, 18B, 18C, 18D gathered together so that mouth 14 remains closed. However, any other suitable alternative may be used to keep flaps 18A, 18B, 18C, 18D gathered together.

Another embodiment of standup bag 210 is shown, for example, in FIGS. 10 and 11. Standup bag 210 includes a closure system 218, a body 220, and a floor 222 as shown in FIGS. 10 and 11. Storage space 216 is defined between body 220 and floor 222 and mouth 214 is formed in body 220 to open into storage space 216 as shown in FIG. 10. Closure system 218 is appended to a top portion of body 220 and configured to selectively close mouth 214 to block access to storage space 216 as shown in FIG. 11. Floor 222 is appended to an opposite bottom portion of body 220 to cause body 220 to extend upwardly away from floor 222 when standup bag is in the unfolded-use position as shown in FIGS. 10 and 11.

Body 220 includes a first wall 231, a second wall 232, a first end wall 233, a second end wall 234, a third end wall 235, and a fourth end wall 236 as shown in FIG. 10. During a bag-forming process in accordance with the present disclosure, first end wall 233 is heat sealed to second end wall 234 along a first heat seal line 225 as shown in FIG. 10. Also, third end wall 235 is heat sealed to fourth end wall 236 along a second heat seal line 226 as shown in FIG. 10. As a result, standup bag 210 may be known as a side-seal bag as a result of being sealed along both first and second heat seal lines 225, 226. Only a single gusset 238 is formed in blown tube when making standup bag 210. As a result, gusset 238 is coupled to itself along first and second heat seal line 225, 226 to establish floor 222 as suggested in FIG. 10.

Closure system 218 is appended to the top portion of body 220 opposite floor 222 and a strip 218A of material which extends mouth 214 as shown in FIG. 10. After items have been placed storage space 216, strip 218A is gathered toward a center of mouth 214 to close mouth 214 as shown in FIG. 11. A tie strap, for example, may be used to keep strip 218A gathered together so that mouth 214 remains closed. However, any other suitable alternative may be used to keep strip 218A gathered together.

### EXAMPLE I

### Co-extruded Films for Standup Bags

Rigid film formulations were prepared using conventional extrusion processes. The formulations of the films are shown in Table 1.

TABLE 1
Film Formulations

| | | Film Formulations | | | |
|---|---|---|---|---|---|
| | | (Approximate Resin | | | |
| | Resin Name and/or | Composition in %) | | | |
| Resin | Supplier | A | B | C | D |
| LDPE | Equistar | 57^{a} | 75^{a} | 21 | 33 |
| HDPE | HDPE Formosa | | | 35 | 25 |
| LLDPE | Exxon NTX095 Super | 30 | 12 | 30 | 30 |
| | Hexene | | | | |
| CaCO₃ | Bayshore | 9 | 10 | 9 | 9 |
| Slip Agent | Ampacet 100088 Slip | 1 | 0 | 0 | 0 |
| | AB | | | | |
| Nucleating Agent | 79899 | 1 | 0 | 3 | 1 |
| Color | SCC-22598 | 2 | 3 | 2 | 2 |
| | 50% Black Standridge | | | | |

^{a}Mixture of re-pelletized regrind of LDPE and HDPE (repro HDPE-LDPE)

### EXAMPLE II

Rigid film formulations C and D from Table 1 were used to produce standup bags 10, 210. The standup bags from film formulations C and D, along with a commercially available bag, were characterized and tested for various properties shown in Table 2.

TABLE 2
Test Data for Various Film Formulations

| | | | | | | Ruffies Pro Stand | |
|---|---|---|---|---|---|---|---|
| Film Formulation | | C | | D | | Tuff Contractor Bags | |
| CLOSURE | | TT | | TT | | TT | |
| Bag Size (Gallon) | | 42 | | 42 | | 42 | |
| Bag Color | | Black | | Black | | Black | |
| Material (HD or LD) | | LD/HD mix | | LD/HD mix | | LD | |
| Seal | | Square | | Square | | Square | |
| | | Bottom | | Bottom | | Bottom | |
| Average Weight | grams | 164 | | 167 | | 148 | |
| Avg Film Thickness^{a} | Mils | 3.3 | | 3.4 | | 3 | |
| MD Tear Strength^{b} | gf | 897 | | N/A | | N/A | |
| Dart Drop Test^{c} | grams | 381 | | 299 | | 296 | |
| Opacity^{d} | % | 100 | | 100 | | 98 | |
| Seam Load at Break^{e} (L-T | Lbf | 8 | N/A | 8 | 7 | N/A | N/A |
| NA) Side, Bottom, or Gusset | | | | | | | |

| | | | | |
|---|---|---|---|---|
| MD Film Load at Break^{e} | Lbf | 17 | 15 | 12 |
| % MD Elongation^{e} | % | 851 | 792 | 851 |
| TD (CD)Film Load at Break^{e} | Lbf | 14 | 13 | 11 |
| % TD (CD) Elongation^{e} | % | 933 | 919 | 929 |

^{a}Standard Guide for Determination of Thickness of Plastic Film Test Specimens (ASTM
D6988-08)
^{b}Standard Test Method for Tear Resistance (Graves Tear) of Plastic Film and Sheeting
(ASTM D1004-08)
^{c}Standard Test Methods for Impact Resistance of Film by Free Falling Dart Method
(ASTM D1709-08)
^{d}Standard Test Method for Transparency of Plastic Sheeting (ASTM D1746-09)
^{e}Standard Test Properties for Tensile Properties of Plastics (ASTM D638-08)
^{f} Standard Test Method for Stiffness of Fabrics (flexural rigidity test by cantilever
bending) (ASTM D1388-08)

### EXAMPLE III

A rigid film formulation is used to produce a standard contractor bag with a square bottom. A bag is produced using in-line extrusion and the formulation as described in Tables 1 and 2 as formulation “C”. A gusset (9 inches) to produce the square bottom feature is inserted in the tower via a gusset board on one side of the bubble.

As the lay flat film reaches the bottom of the tower, it enters into a 50 inch Hudson Sharp shuttle bag machine. The machine uses two sealing heads (front and back) with heated bottom plenums for increasing the seal quality. This produces the bag's side seal from the top to the bottom of the bag, including the gusset area at the bottom of the bag. A perforation blade is between the front and the back sealing head allowing the separation of each bag.

After the sealing and perforation in the shuttle bag machine, the film is folded twice on a stand-alone folder. The folded, individual perforated bags are then winded on a spinner winder at a pre-set count.

### EXAMPLE IV

A rigid film formulation is used to produce a standard contractor bag with a square bottom. A bag is produced using in-line extrusion and the formulation as described in Tables 1 and 2 as formulation “C”. A gusset (8.5 inches) to produce the square bottom feature is inserted in the tower via a gusset board on both sides of the bubble.

As the lay flat film reaches the bottom of the tower, it enters into a 50 inch Hudson Sharp shuttle bag machine. The machine uses one sealing head with a heated bottom plenum for increasing the seal quality. This produces the bag's bottom seal from the left to the right at the bottom of the bag, including the gusset area on the left and right side of the bag. A perforation blade is located next to the sealing head allowing the separation of each bag.

An angle seal is used to seal both gussets at the bottom of the bag next to the seal. These seals are at a 45 degree angle from the bottom seal. The angle seal touches the bottom seal starting at the center of the bag or the start of the side gussets and is at a 45 degree angle away from the bottom seal to the outer edge of the bag on both sides (left and right of the bag). The angle seal gives the bottom of the bag when opened a square bottom.

After the sealing and perforation in the shuttle bag machine, the film is folded twice on a stand-alone folder. The folded, individual perforated bags are then winded on a spinner winder at a pre-set count.

### EXAMPLE V

The blended HDPE/LDPE resin formulation C (see Tables 1 and 2) was tested for rigidity/stiffness using ASTM D1388-08. This ASTM method was reapproved in 2012. In particular, the resin was tested using the cantilever test, which employs cantilever bending of the resin under its own mass.

In the cantilever test, a specimen from the blended HDPE/LDPE resin formulation C was slid at a specified rate in a direction parallel to its long dimension, until its leading edge projected from the edge of the horizontal surface. The length of the overhang was measured when the tip of the specimen was depressed under its own mass to the point where the line joined the top to the edge of the platform made a 41.5° angle with the horizontal. From this measured length, the bending length and flexural rigidity were calculated.

TABLE 3
Rigidity Test Data for Formulation C

| Film Formulation | | | C |
|---|---|---|---|
| CLOSURE | | | TT |
| Bag Size (Gallon) | | | 42 |
| Bag Color | | | Black |
| Material (HD or LD) | | | LD/HD mix |
| Seal | | | Square Bottom |
| Flexural | Outside Face | mg*cm | 348 |
| Rigidity | Inside Face | mg*cm | 404 |
| Test | Overall | mg*cm | 376 |

1. A rigid polyolefin film comprising
high density polyethylene (HDPE) and
low density polyethylene (LDPE).

2. The rigid polyolefin film of claim 2, wherein the HDPE and LDPE comprises about 50% to about 80% of the weight of the film.

3. The rigid polyolefin film of claim 3, wherein the HDPE comprises about 20% to about 40% of the weight of the film.

4. The rigid polyolefin film of claim 2, wherein the HDPE comprises about 25% to about 35% of the weight of the film.

5. The rigid polyolefin film of claim 2, wherein the LDPE comprises about 20% to about 40% of the weight of the film.

6. The rigid polyolefin film of claim 2, wherein the LDPE comprises about 20% to about 35% of the weight of the film.

7. The rigid polyolefin film of claim 1 further comprising linear low density polyethylene (LLDPE).

8. The rigid polyolefin film of claim 7, wherein the LLDPE comprises about 30% of the weight of the film.

9. The rigid polyolefin film of claim 7, wherein the LLDPE is a super hexene.

10. The rigid polyolefin film of claim 9, wherein the flexural rigidity is about 325 mg*cm to about 450 mg*cm when tested by ASTM D1388-08.

11. The rigid polyolefin film of claim 1, wherein the rigid polyolefin film has a flexural rigidity of at least 325 mg*cm when tested by ASTM D1388-08.

12. The rigid polyolefin film of claim 1 further comprising a slip agent.

13. The rigid polyolefin film of claim 1 further comprising calcium carbonate.

14. The rigid polyolefin film of claim 1, wherein the LDPE comprises about 20% to about 35% of the weight of the film and the HDPE comprises about 25% to about 35% of the weight of the film.

15. The rigid polyolefin film of claim 14, further comprising a linear low density polyethylene (LLDPE).

16. The rigid polyolefin film of claim 15, wherein the LLDPE comprises about 30% of the weight of the film.

17. The rigid polyolefin film of claim 16, further comprising a nucleating agent.

18. The rigid polyolefin film of claim 17, wherein the nucleating agent comprises about 1% to about 3% of the weight of the film.

19. The rigid polyolefin film of claim 14, further comprising a liner low density polyethylene (LLDPE) comprising about 30% of the weight of the film and a nucleating agent comprising about 1% to about 3% of the weight of the film.

20. The rigid polyolefin film of claim 19, wherein the rigid polyolefin film has a flexural rigidity of at least 325 mg*cm when tested by ASTM D1388-08.

21. The rigid polyolefin film of claim 19, wherein the flexural rigidity is about 325 mg*cm to about 450 mg*cm when tested by ASTM D1388-08.

22. A bag comprising
a floor and
a body coupled to the floor to extend upwardly away from the floor and define a storage space therebetween, the body being formed to include a mouth opening into the storage space to permit items to be placed into the storage space,
wherein the body is made from a material configured to provide means for supporting the body on ground underlying the body after the bag has been has been unfolded and arranged to be free standing without support from a user or other bag-support structures so that the mouth opens into the storage space.

23. The bag of claim 22, wherein the material comprises high density polyethylene (HDPE) and low density polyethylene (LDPE).

24. The bag of claim of claim 23, wherein the LDPE comprises about 20% to about 35% of the weight of the bag and the HDPE comprises about 25% to about 35% of the weight of the bag.

25. The bag of claim 24, wherein the material further comprises a liner low density polyethylene (LLDPE) comprising about 30% of the weight of the bag and a nucleating agent comprising about 1% to about 3% of the weight of the bag.

26. The bag of claim 25, wherein the flexural rigidity is about 325 mg*cm to about 450 mg*cm when tested by ASTM D1388-08.

27. The bag of claim 26, wherein the LLDPE is a super hexene.
